(19) United States
(12) Patent Application Publication
(10) Pub. No.: US 2013/0318870 A1
(43) Pub. Date: Dec. 5, 2013

(54) APPLICATIONS OF THE BITTERN PRODUCED USING THE EVAPORATION PROCESS OF THE FLOATING SALT FARM

(71) Applicant: JAE HYUN LIM, CRESSKILL, NJ (US)

(72) Inventor: JAE HYUN LIM, CRESSKILL, NJ (US)

(21) Appl. No.: 13/968,273

(22) Filed: Aug. 15, 2013

(51) Int. Cl. A01G 1/00; C09K 3/18; F03G 7/04

(52) U.S. Cl. CPC A01G 1/001; F03G 7/04; C09K 3/18
USPC 47/58.1 SC; 60/327; 252/70

(57) ABSTRACT

A Floating Salt Farm is an offshore system in which its purpose is to produce crystallized salt and bittern using the evaporation process. This present application is regarding three different applications of the bittern produced using the Floating Salt Farm: (1) An osmotic power (or salinity gradient power) plant is used jointly with the Floating Salt Farm to generate electricity at offshore locations by using produced bittern and extracted seawater; (2) The bittern and/or crystallized salt to be used to melt ice and snow are produced with the Floating Salt Farm by using seawater, in which has been affected by volcanic activities and has substantial silica content (silicon dioxide); (3) In a halophyte farm, where there may not be saline water readily available, the bittern produced using the Floating Salt Farm is applied to the saline soil to adjust its salinity level to maintain proper conditions for halophytes.

### CROSS-REFERENCE TO RELATED APPLICATIONS

The present application is a division of U.S. application Ser. No. 13/662,534, filed Oct. 28, 2012, the contents of which are herein incorporated by reference in their entirety.

### FIELD OF THE INVENTION

Applications of the bittern produced using the evaporation process of the Floating Salt Farm.

### BACKGROUND OF THE INVENTION

A Floating Salt Farm is an offshore system which uses extracted seawater to produce crystallized salt and bittern with desired properties, such as mineral composition, through the evaporation process. This present application is regarding three different applications of the bittern produced using the Floating Salt Farm.

A method of generating electricity is by using osmotic power (or salinity gradient power). Osmotic power is the energy acquirable by using the osmotic pressure difference between two different types of water with different salinity levels, in which the energy is used to generate electricity. By traditional methods, two different types of water with different salinity levels are used: (1) seawater, which is extracted from the sea, and (2) freshwater, which can be extracted from rivers. Therefore, by traditional methods, osmotic power plants must be at locations where seawater and freshwater are readily available to be extracted, such as at river deltas, which are then used to generate electricity. However, by using the Floating Salt Farm jointly with an osmotic power (or salinity gradient power) plant, the osmotic power plant can be installed and used at any offshore location regardless whether there would be a freshwater source available to be used. The bittern produced using the Floating Salt Farm would be used instead to generate electricity with the osmotic power plant, in which the used bittern would be reliably and regularly delivered to the osmotic power plant from the Floating Salt Farm.

Conventionally, when ice and snow on the ground, such as on pavements in urban areas, need to be melted, salt brine and/or granular salt are applied to the ice and snow. However, by using salt brine or granular salt to melt the ice and snow, metals and other materials can react to the applied salt brine or granular salt, and undergo corrosion. To lessen the corrosion of metals and other materials when melting the ice and snow, bittern and/or crystallized salt produced from the Floating Salt Farm can be applied. The bittern and/or crystallized salt from the Floating Salt Farm would be produced to have suitable properties to lessen corrosion of metals and other materials when used to melt the ice and snow.

Halophytes, which are plants which use saline water, naturally grow near bodies of saline water, such as on the seaside. Halophytes grown in a halophyte farm, however, can be grown without being located near saline water sources because the halophytes are maintained by adjusting the saline soil to have the suitable salinity and properties. However, in a halophyte farm, where there may not be saline water sources readily available, bittern produced with the Floating Salt Farm can be used to maintain suitable conditions of the saline soil of the halophytes.

### BRIEF SUMMARY OF THE INVENTION

A Floating Salt Farm is an offshore system in which its purpose is to produce crystallized salt and bittern using the evaporation process. The Floating Salt Farm can be operated continuously at any time and at any location, in the condition that energy sources are reliably and regularly supplied. Different energy sources can be used in combination to supply the operating Floating Salt Farm with energy continuously. The extracted seawater, which is used to produce the crystallized salt and bittern with the Floating Salt Farm, can have properties, such as mineral composition, which have been affected by volcanic activities. Crystallized salt and bittern can also be produced with the Floating Salt Farm by using seawater extracted at various water depths, in which the extracted seawater can have suitable and/or desired mineral compositions. The properties of the produced crystallized salt and bittern, such as mineral composition, can also be affected by placing contents inside the evaporator tank of the Floating Salt Farm with the extracted seawater during the evaporation process. This present application is regarding three different applications of the bittern produced using the Floating Salt Farm.

An osmotic power (or salinity gradient power) plant can be used jointly with the Floating Salt Farm to generate electricity at any offshore location by using the bittern produced with the Floating Salt Farm and regardless whether there would be a freshwater source available to be used. To generate electricity using osmotic power (or salinity gradient power), two different types of water with different salinity levels are used. By traditional methods, an osmotic power plant uses (1) seawater, which is extracted from the sea, and (2) freshwater, which can be extracted from rivers, to generate electricity. However, for an osmotic power plant used jointly with the Floating Salt Farm, the two different types of water with different salinity levels used instead would be: (1) bittern, which is produced using the Floating Salt Farm and has a higher salinity level than the seawater used, and (2) seawater, which is extracted from the sea and has a lower salinity level than the bittern used. Therefore, by using the osmotic power plant jointly with the Floating Salt Farm, in place of using seawater and freshwater, bittern and seawater would be used instead. The salinity level of the bittern produced with the Floating Salt Farm to be used for the osmotic power plant, can be adjusted to have the desired salinity level. For osmotic power plants, the salinity level difference between the two different types of water used, determines the power output of the osmotic power plant. Therefore, by adjusting the salinity level of the bittern produced with the Floating Salt Farm, the power output of the osmotic power plant can be controlled.

When melting ice and snow on the ground, such as on pavements in urban areas, salt brine and/or granular salt are applied on the ice and snow. However, metals, such as steel, and other materials can react to the applied salt brine and/or granular salt and undergo corrosion. However, the corrosion of metals and other materials caused by salt brine and/or granular salt can be lessened by instead applying bittern and/or crystallized salt with suitable properties produced using the Floating Salt Farm. The bittern and/or crystallized salt would be produced by using seawater which has been affected by volcanic activities, in which the seawater would have a substantial amount of silica content (silicon dioxide). By using this affected seawater, bittern and/or crystallized salt which are high in silica content can be produced using the evaporation process of the Floating Salt Farm. The silica content of the produced bittern and/or crystallized salt to be used to melt ice and snow can lessen the corrosion of affected metals and other materials. Therefore, when melting the ice and snow on the ground, by using the bittern and/or crystallized salt which are both high in silica content, the corrosion of affected metals and other materials would be less compared to the corrosion caused by using conventional salt brine and/or granular salt.

Halophytes, plants which are grown on saline soil, naturally grow near bodies of saline water, such as on the seaside. However, in a halophyte farm, where there may not be saline water readily available for use, the soil conditions of the halophyte farm must be maintained to have suitable soil conditions for halophytes. In order to adjust the salinity of the soil of the halophyte farm, the produced bittern from the Floating Salt Farm can be delivered to the halophyte farm and applied accordingly to adjust the salinity of the saline soil. By using the produced bittern from the Floating Salt Farm instead of using saline water, which can be seawater, the volume of the produced bittern to be delivered to and used for the halophyte farm to adjust the salinity of the saline soil, would be much less because the salinity of the produced bittern is much higher than the salinity of seawater. The purpose of the produced bittern delivered to the halophyte farm is to maintain suitable conditions of saline soil of the halophytes. The produced bittern would have desired mineral compositions, in which the mineral composition of the bittern would influence the mineral composition of the saline soil of the halophyte farm.

### BRIEF DESCRIPTION OF DRAWINGS

FIG. 1A is a top view of the buoyant foundation of the Floating Salt Farm and the Floating Salt Farm components.

FIG. 1B is a side view of a Floating Salt Farm reinforced with offshore structures and a Floating Salt Farm moved by towboat.

FIG. 1C is a top view of an embodiment of the Floating Salt Farm with an installed motor propeller component.

FIG. 2 is an illustration of the osmotic power (or salinity gradient power) process by using two different types of water with different salinity levels.

FIG. 3A is a top view of an embodiment of an osmotic power (or salinity gradient power) plant used jointly with a Floating Salt Farm.

FIG. 3B is a side view of the bittern tube supported by the buoyant connection support.

FIG. 4A is a top view of an embodiment of the osmotic power plant used jointly with the Floating Salt Farm, in which both are installed on a single buoyant foundation.

FIG. 4B is a top view of an embodiment of the osmotic power plant used jointly with the Floating Salt Farm where the osmotic power plant is reinforced with a combination of onshore structures and offshore structures.

FIG. 4C is a side view of the detachable connection between the buoyant foundation of the osmotic power plant and the offshore structure.

FIGS. 4D and 4E are top views of embodiments of the osmotic power plant moved by an installed motor propeller component or towboats, respectively.

FIG. 4F is a top view of the osmotic power plant, which is installed onshore.

FIGS. 5A and 5B are a top view and a side view of the seawater extraction vessel, respectively.

FIGS. 5C and 5D are side views of underwater volcanoes and volcanoes located above sea level, respectively, in which have affected the seawater to be extracted.

FIG. 6 is a side view of a halophyte farm.

FIGS. 7A and 7B are side views of embodiments of the evaporator tank to be used for the evaporation process of the Floating Salt Farm.

### DETAILED DESCRIPTION OF THE INVENTION

Detailed embodiments of the invention can be illustrated using the accompanying drawings as reference.

A Floating Salt Farm is an offshore system in which its purpose is to produce crystallized salt and bittern through the evaporation process using extracted seawater.

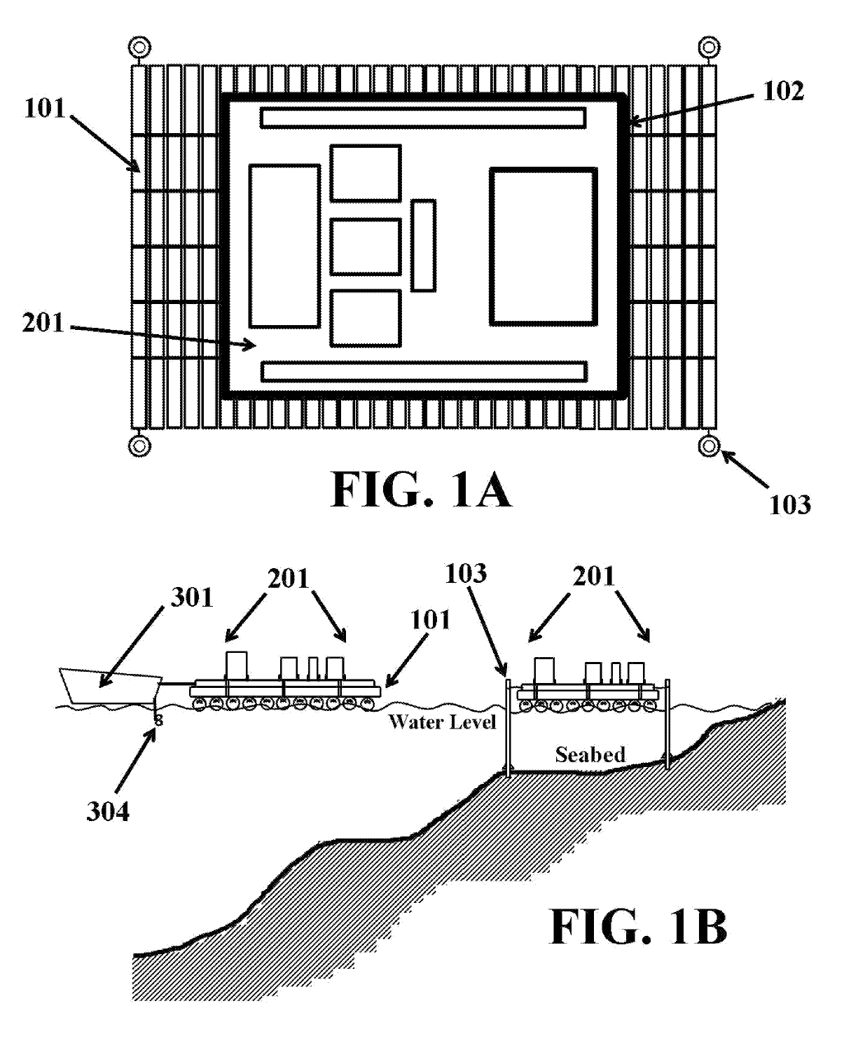

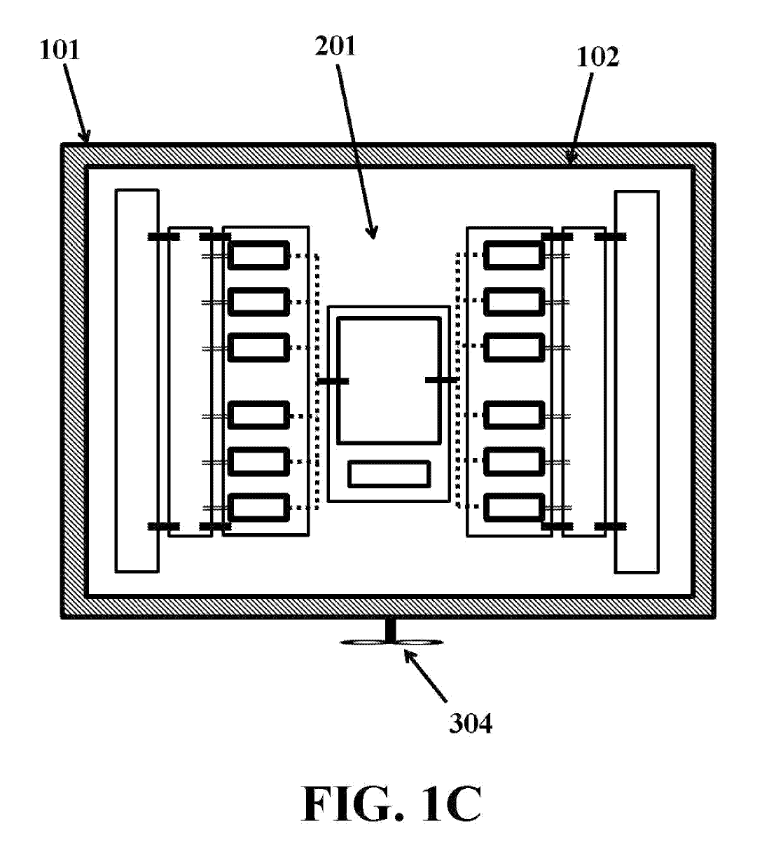

The buoyant foundation 101 of the Floating Salt Farm must have sufficient buoyancy and be able to support the weight of the Floating Salt Farm components 201, as shown in FIG. 1A. The Floating Salt Farm components 201 are installed on the flooring deck 102, in which the flooring deck 102 is fixed onto the top of the buoyant foundation 101. The stability of the Floating Salt Farm must be sufficient to withstand inclement weather conditions and hitting sea waves.

The Floating Salt Farm can be reinforced with offshore structures 103. At locations where the Floating Salt Farm cannot be reinforced with offshore structures 103, the Floating Salt Farm can be moved by towboat 301, as shown in FIG. 1B, or can have an installed motor propeller component 304, as shown in FIG. 1C, when transporting the Floating Salt Farm to a certain offshore location to extract seawater for the evaporation process or moving the Floating Salt Farm to a safe location during times of inclement weather conditions. The buoyant foundation 101 of the Floating Salt Farm can be a barge with an installed motor propeller component 304, as shown in FIG. 1C. However, at locations where higher stability may be needed, such as at locations with recurring inclement weather conditions, some components of the Floating Salt Farm can be separated and placed at a safe location, such as the harbor.

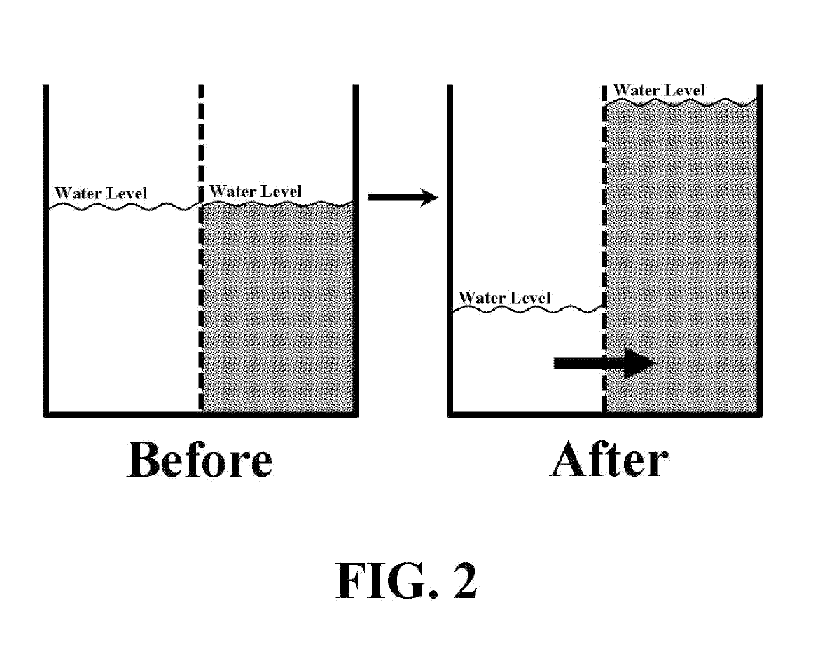

A method of generating electricity is by using osmotic power (or salinity gradient power). Osmotic power is the energy acquirable by using the osmotic pressure difference between two different types of water with different salinity levels, as shown in FIG. 2.

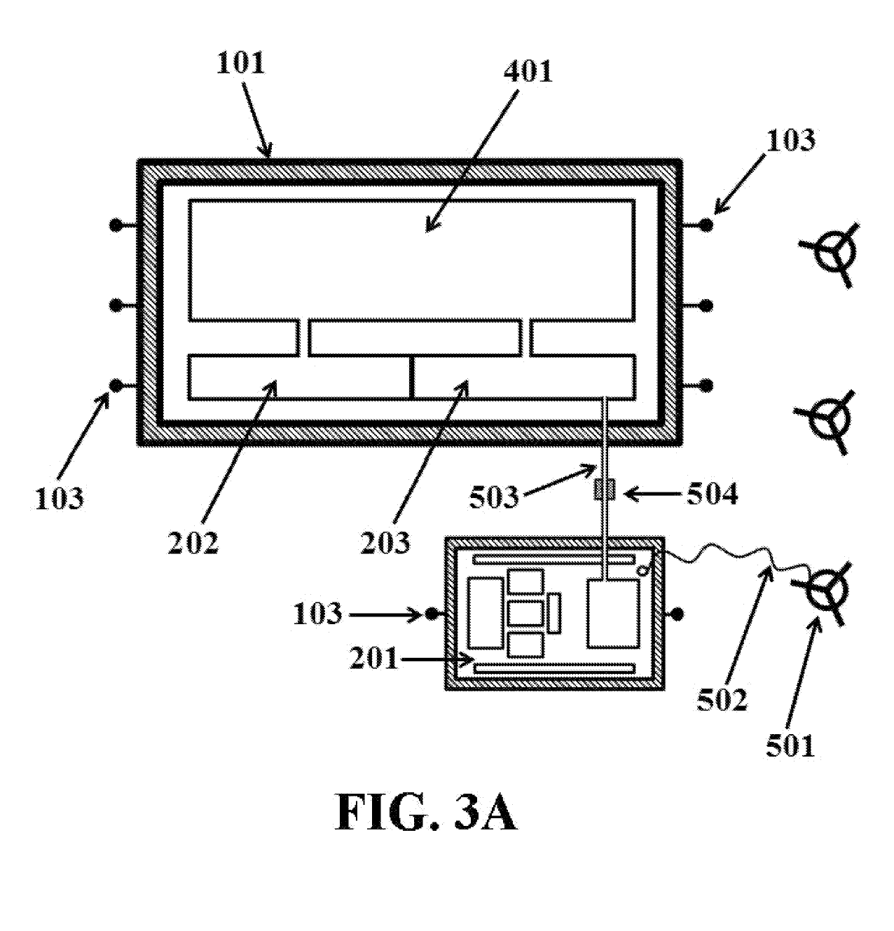

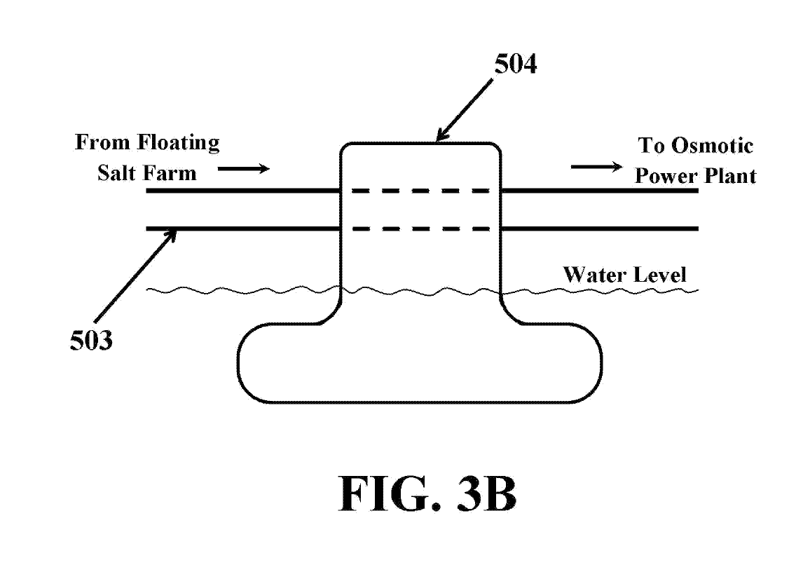

An osmotic power (or salinity gradient power) plant 401 is a system which uses osmotic pressure difference to generate electricity. An osmotic power plant 401 can be used jointly with the Floating Salt Farm, as shown in FIG. 3A, to generate electricity at any offshore location by using the bittern produced with the Floating Salt Farm and regardless whether there would be a freshwater source available to be used. The osmotic power plant 401 is installed on the buoyant foundation 101, as shown in FIG. 3A, in which the buoyant foundation 101 must have sufficient buoyancy and stability, and be able to support the weight of the osmotic power plant 401. The buoyant foundation 101 can be reinforced with offshore structures 103.

To generate electricity using the osmotic power plant 401 used jointly with the Floating Salt Farm, two different types of water with different salinity levels are used: (1) bittern, which is produced using the Floating Salt Farm and has a higher salinity level than the seawater used, and (2) seawater, which is extracted from the sea and has a lower salinity level than the bittern used. The bittern used for the osmotic power plant 401 is delivered from the Floating Salt Farm to the bittern supply tank 203 of the osmotic power plant 401 through the bittern tube 503, as shown in FIG. 3A. The seawater used for the osmotic power plant 401 can be extracted into the seawater supply tank 202 of the osmotic power plant 401.

Offshore wind turbines 501 can be used to supply electricity to power the Floating Salt Farm, as shown in FIG. 3A. The offshore wind turbines 501 can also be used to supply electricity to power both the osmotic power plant 401 and the jointly used Floating Salt Farm.

The osmotic power plant 401 can be used jointly with the Floating Salt Farm, in which the energy sources used to operate Floating Salt Farm are reliably and regularly supplied. These energy sources can also be jointly used to operate the osmotic power plant 401 and Floating Salt Farm continuously at any time, in the condition that energy sources are reliably and regularly supplied.

The bittern produced with the Floating Salt Farm is delivered to the osmotic power plant 401 through the bittern tube 503, which is connected between the Floating Salt Farm and the osmotic power plant 401, as shown in FIG. 3A. The bittern tube 503 is installed as an additional component of the Floating Salt Farm and can be supported by a buoyant connection support 504, as shown in FIG. 3B.

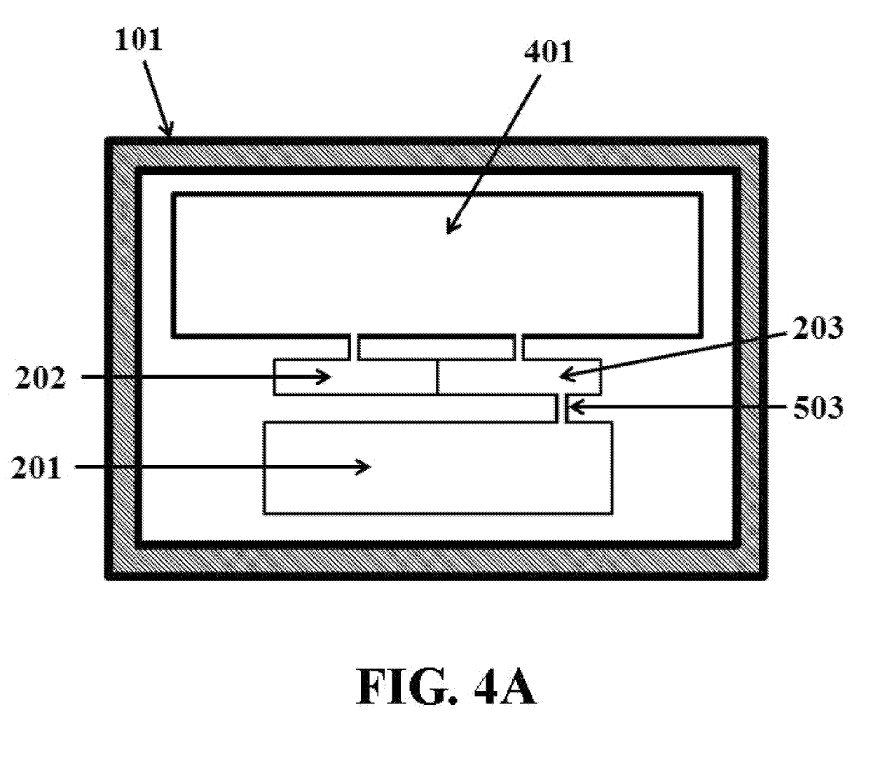

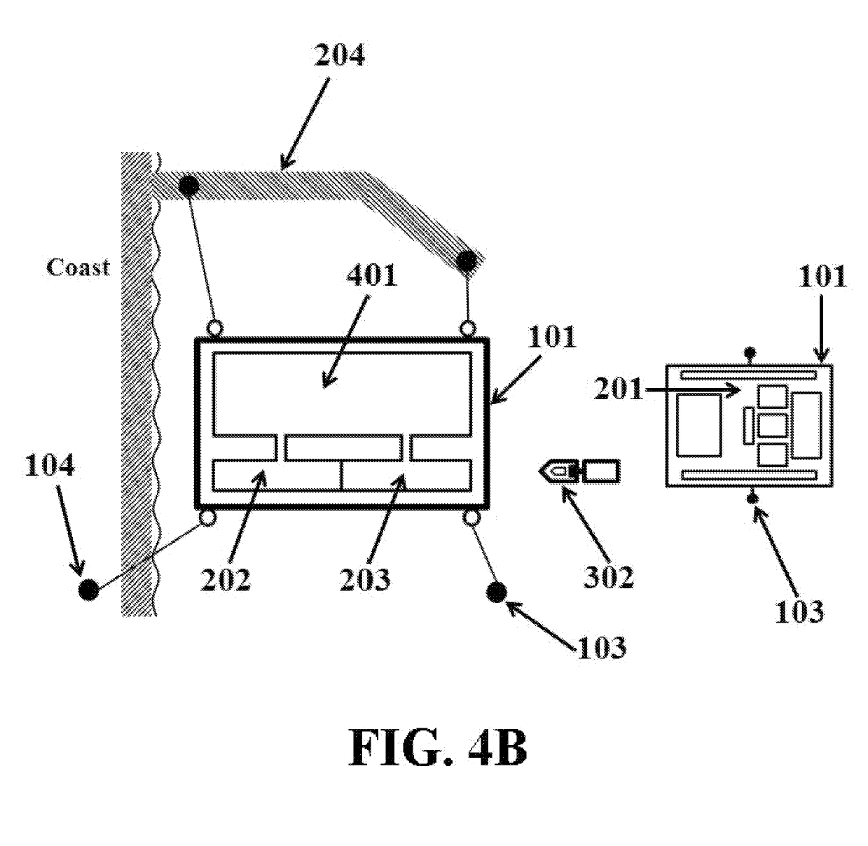

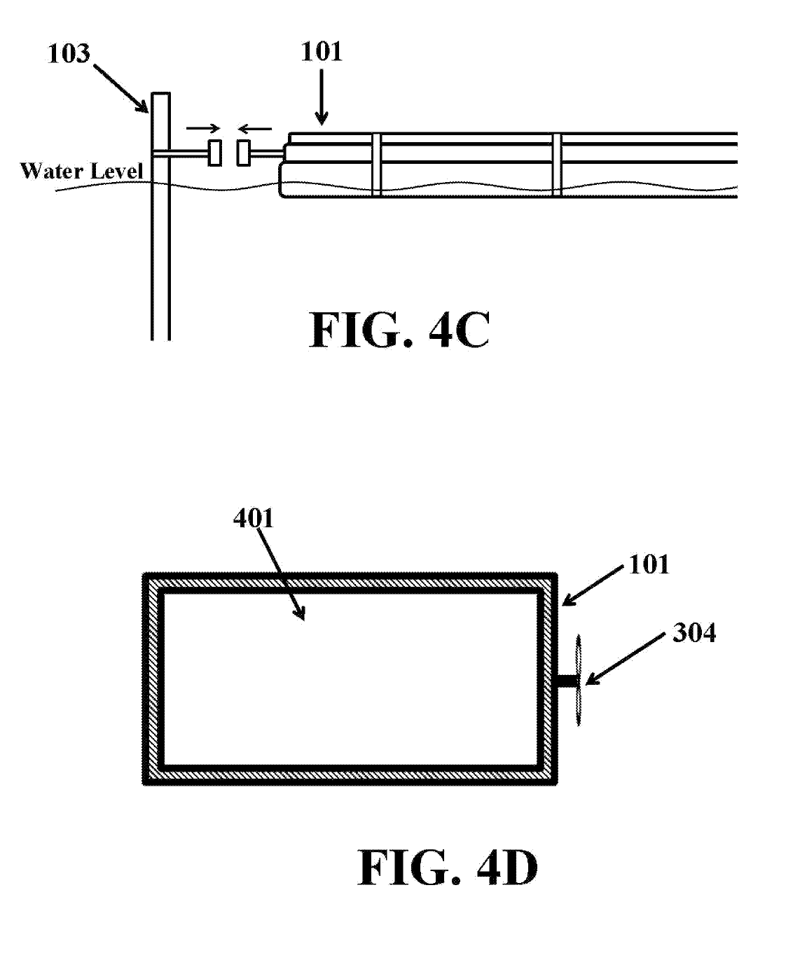

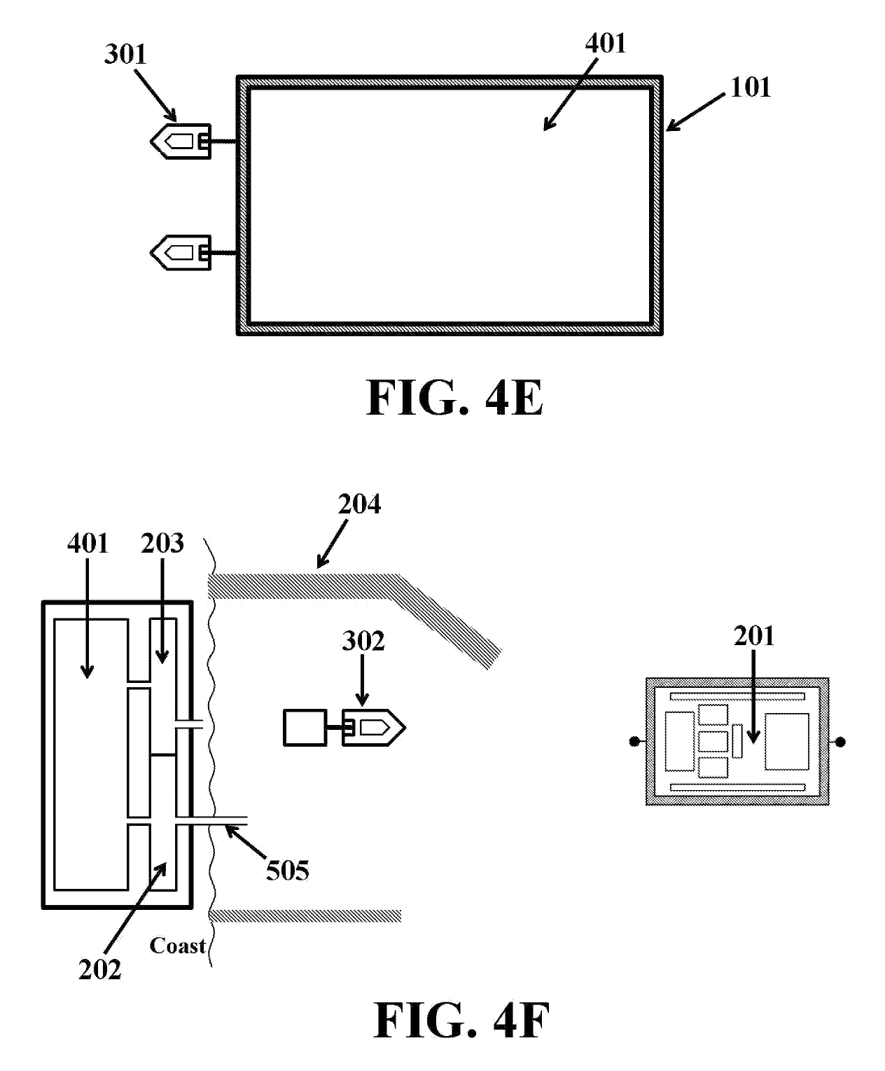

An embodiment of the osmotic power plant 401 used jointly with the Floating Salt Farm, in which both are installed on a single buoyant foundation 101, is shown in FIG. 4A. In this embodiment, the buoyant foundation 101 has sufficient buoyancy and stability to support both the osmotic power plant 401 and Floating Salt Farm components 201.

At locations where higher stability may be needed, such as at locations with recurring inclement weather conditions, the osmotic power plant 401 can be installed at a safe location, such as the harbor with a breakwater 204 as shown in FIG. 4B. In this embodiment, the osmotic power plant 401 is reinforced with a combination of onshore structures 104 and offshore structures 103. The bittern produced with the Floating Salt Farm can be continuously and reliably delivered to the osmotic power plant 401 by transport vessel 302.

The buoyant foundation 101, in which the osmotic power plant 401 is installed onto, can be connected to an offshore structure 103, which is used to reinforce the buoyant foundation 101 of the osmotic power plant 401, as shown in FIG. 3A. The connection between the offshore structure 103 and the buoyant foundation 101 of the osmotic power plant 401 can be detachable, as shown in FIG. 4C.

The buoyant foundation 101 of the osmotic power plant 401 can have an installed motor propeller component 304, as shown in FIG. 4D, or can be moved by towboats 301, as shown in FIG. 4E, when transporting the osmotic power plant 401 to a safe location during inclement weather conditions or to locations where the bittern produced with the Floating Salt Farm can be received. The buoyant foundation 101 of the osmotic power plant 401 can be a barge with an installed motor propeller component 304, as shown in FIG. 4D.

The bittern produced with the Floating Salt Farm, which is located offshore, can be reliably and continuously delivered through a transport vessel 302 to the osmotic power plant 401, which is installed onshore, as shown in FIG. 4F. In this embodiment, the osmotic power plant 401, which is installed onshore, can extract seawater used for the osmotic power plant 401 using a seawater extraction tube 505 installed on the seawater supply tank 202 of the osmotic power plant 401.

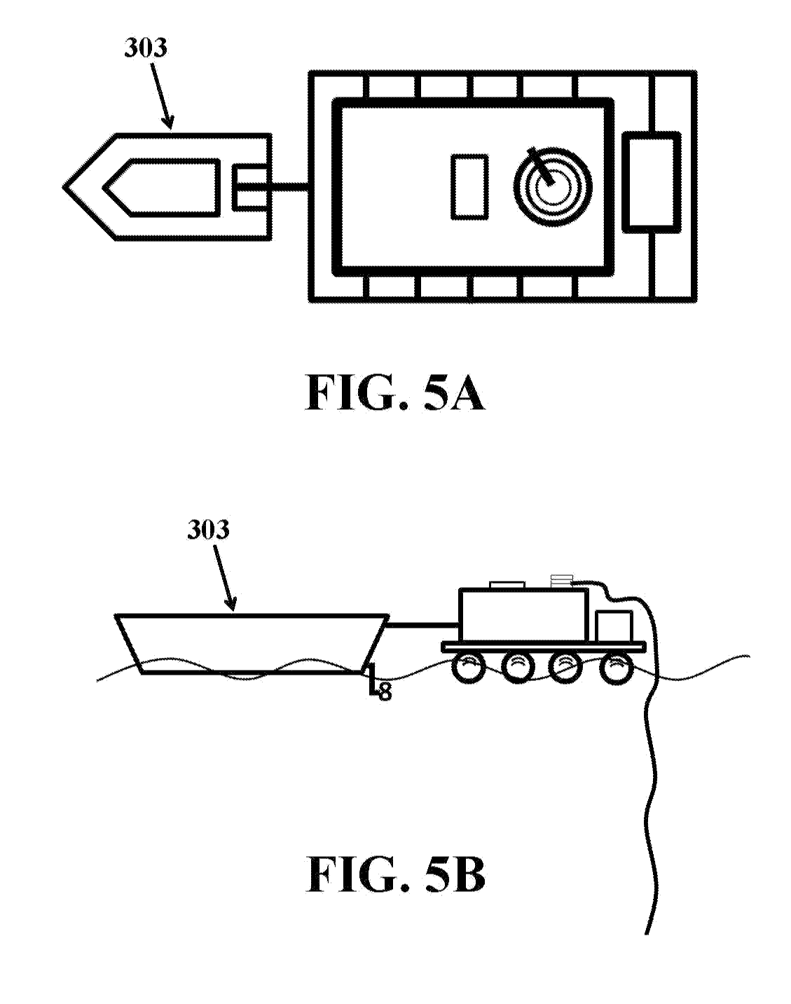

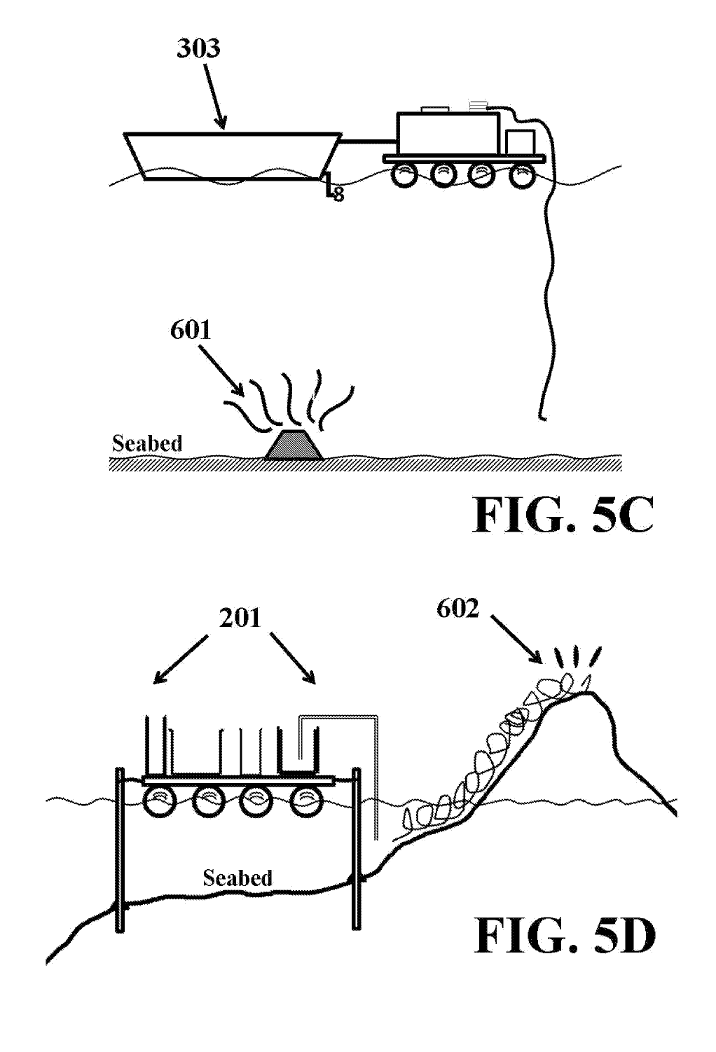

The seawater to be used for the Floating Salt Farm can be extracted at various water depths at a certain offshore location to extract seawater with desired mineral composition using a seawater extraction vessel 303, as shown in FIGS. 5A and 5B. The extracted seawater is then delivered to the Floating Salt Farm to be used for the evaporation process of the Floating Salt Farm to produce crystallized salt and bittern.

The extracted seawater, in which has been affected by volcanic activities and used to produce crystallized salt and bittern with Floating Salt Farm, can have a substantial amount of silica content (silicon dioxide). The volcanic activities, in which have affected the seawater to be extracted and used for the evaporation process of the Floating Salt Farm, can be from underwater volcanoes 601, as shown in FIG. 5C, and/or from volcanoes located above sea level 602, as shown in FIG. 5D. By using this affected seawater, the crystallized salt and bittern, which are produced using the evaporation process of the Floating Salt Farm, can have a substantial amount of silica content.

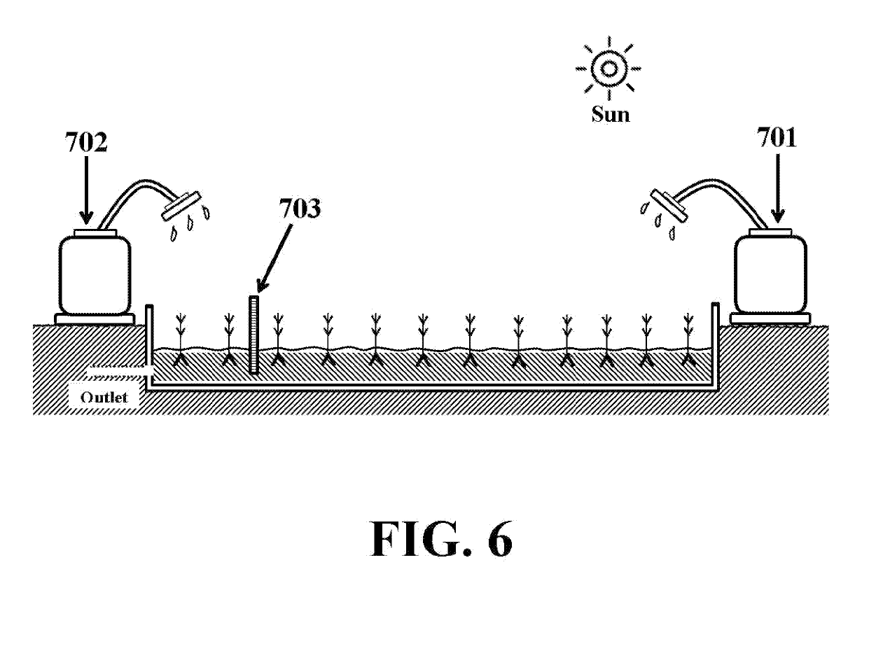

The saline soil of the halophyte farm, as shown in FIG. 6, in which the location of the halophyte farm may be at a location where there may not be saline water readily available for use, must be maintained to have suitable saline soil conditions for halophytes. The bittern produced with the Floating Salt Farm is delivered to the bittern deposit tank 701 to be used to adjust the salinity level of the saline soil of the halophyte farm. The bittern from the bittern deposit tank 701 and the freshwater from the freshwater deposit tank 702 are used to adjust the salinity level of the saline soil of the halophyte farm. The saline soil conditions of the halophyte farm are monitored using a salinity level gauge 703, and the bittern and/or freshwater are applied accordingly to maintain the salinity level of the saline soil at proper conditions. The saline soil of the halophyte farm is enclosed by borders, as shown in FIG. 6, to separate the saline soil of the halophyte farm from the soil unused by the halophyte farm. The halophyte farm has an outlet to allow excess saline water to be separated from the saline soil. The excess saline water is gathered and treated before discarding.

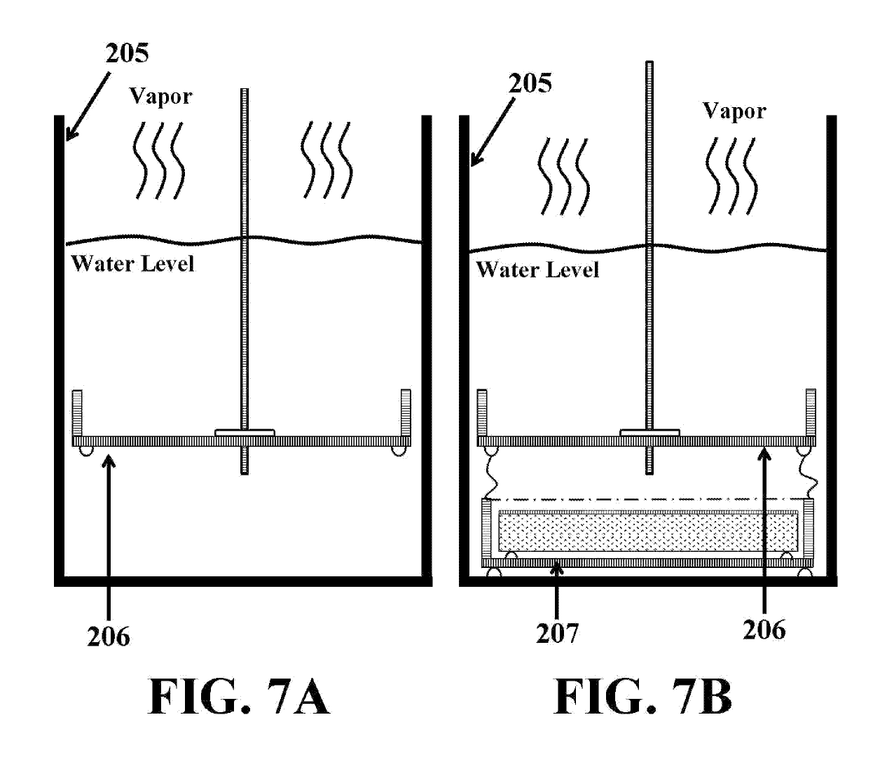

The salinity level and the silica content of the produced crystallized salt and bittern can be modified by adjusting the heating temperature and heating time of the evaporation process of the Floating Salt Farm accordingly. Another method to increase the salinity level and the silica content of the produced bittern can be by reusing the produced bittern for other additional and multiple evaporation process cycles of the Floating Salt Farm, in which, after each evaporation process cycle, additional extracted seawater and/or other previously produced bittern would be added to the evaporator tank 205, as shown in FIG. 7A, and mixed with the produced bittern for the following evaporation process cycle. By running the evaporation process multiple cycles, the salinity level and the silica content of the produced bittern can be produced to be higher and at a desired salinity level and silica content.

The contents and properties, such as mineral composition, of the produced crystallized salt and bittern can be affected by placing contents inside the evaporator tank 205 of the Floating Salt Farm using the extracted seawater during the evaporation process. An embodiment of the evaporator tank 205, which has an evaporator plate component 206 installed, is shown in FIG. 7A, in which the contents are placed below the evaporator plate component 206 with the extracted seawater for the evaporation process. Another embodiment of the evaporator tank 205, which has an evaporator bin component 207 linked to the bottom of the evaporator plate component 206, is shown in FIG. 7B, in which the contents are placed inside the evaporator bin component 207 with the extracted seawater for the evaporation process.

What is claimed is:

1. A method to generate electricity by using an osmotic power (or a salinity gradient power) plant, which is installed at an offshore location and used jointly with a Floating Salt Farm, by using bittern, which is produced using the Floating Salt Farm and has a higher salinity level than the seawater used for the osmotic power plant, and using seawater, which is extracted from the sea and has a lower salinity level than the bittern used for the osmotic power plant.

2. The method according to claim 1, wherein the said osmotic power plant is moveable by using an installed motor propeller component or is moveable by using towboats.

3. The method according to claim 1, wherein the said osmotic power plant is reinforced with offshore structures and the connection between each offshore structure and the buoyant foundation of the said osmotic power plant is detachable.

4. The method according to claim 3, wherein the said osmotic power plant is reinforced with a combination of said offshore structures and onshore structures.

5. The method according to claim 1, wherein the said osmotic power plant and the said jointly used Floating Salt Farm are both installed on a single buoyant foundation.

6. The method according to claim 1, wherein the said osmotic power plant is installed onshore.

7. The method according to claim 1, wherein the salinity level of the said bittern used for the said osmotic power plant, is adjustable.

8. The method according to claim 1, wherein the said osmotic power plant and the said jointly used Floating Salt Farm both use electricity supplied by offshore wind turbines to power the said osmotic power plant and the said jointly used Floating Salt Farm.

9. The method according to claim 1, wherein the said osmotic power plant and the said jointly used Floating Salt Farm are both continuously supplied with energy sources to be able to jointly and continuously operate both the said osmotic power plant and the said jointly used Floating Salt Farm.

10. A method to melt ice and snow by using bittern and/or crystallized salt having a substantial amount of silica content (silicon dioxide), which are produced with the evaporation process of the Floating Salt Farm by using extracted seawater which has been affected by volcanic activities and has a substantial amount of silica content.

11. The method according to claim 10, wherein the said volcanic activities, in which have affected the said extracted seawater to be used for the said evaporation process of the Floating Salt Farm, are from underwater volcanoes.

12. The method according to claim 10, wherein the said volcanic activities, in which have affected the said extracted seawater to be used for the said evaporation process of the Floating Salt Farm, are from volcanoes located above sea level.

13. The method according to claim 10, wherein the said amount of silica content of the said produced bittern and/or crystallized salt used for melting said ice and snow, is adjustable.

14. A method to grow halophytes by using the bittern produced with the Floating Salt Farm to adjust the salinity level of the saline soil of the halophytes at locations where saline water sources may not be available for use.

15. The method according to claim 14, wherein the said bittern used to grow said halophytes has desired mineral compositions, which influence the said saline soil of the said halophytes.
